(19) United States
(12) Patent Application Publication
(10) Pub. No.: US 2026/0300210 A1
(43) Pub. Date: Oct. 1, 2026

(54) MANAGING OPERATION MODES OF PERIPHERAL COMPONENT INTERCONNECT EXPRESS (PCIe) SWITCHES

(71) Applicant: Aivres Systems Inc., San Jose, CA (US)

(72) Inventor: Chungyu CHEN, New Taipei City (TW)

(21) Appl. No.: 19/092,941

(22) Filed: Mar. 27, 2025

(51) Int. Cl. G06F 13/42

(52) U.S. Cl. CPC G06F 13/4221; G06F 2213/0026

(57) ABSTRACT

Methods, devices, and systems for managing operation modes of a peripheral component interconnect express (PCIe) switch are provided. In one aspect, a device includes at least PCIe switch correspondingly coupled to one or more PCIe devices; and a PCIe controller coupled to a device controller and the at least one PCIe switch. The device controller is configured to determine a target mode of the at least one PCIe switch based on a performance metric of each of the one or more PCIe devices. The PCIe controller is configured to: receive a control signal indicative of the target mode of the at least one PCIe switch from the device controller; and based on the control signal, output a configuration signal indicative of the target mode to the at least one PCIe switch to set a mode of the at least one PCIe switch to be the target mode.

### TECHNICAL FIELD

The present disclosure is related to Peripheral Component Interconnect Express (PCIe) data transmissions.

### BACKGROUND

Computing devices, such as servers, are widely used in a variety of fields. In areas such as artificial intelligence (AI) and big data, the need for computing is growing rapidly. To improve flexibility and computational efficiencies, some computing devices are configured to include different external devices within the same server chassis, making the computing devices suitable for a variety of applications. Some computing devices use a Peripheral Component Interconnect Express (PCIe) bus to connect the external devices to processing devices on a motherboard.

### SUMMARY

The present disclosure describes systems and techniques for managing operation modes of PCIe switches in a host system.

In an implementation, a device includes at least one peripheral component interconnect express (PCIe) switch correspondingly coupled to one or more PCIe devices; and a PCIe controller including an input port coupled to a device controller and at least one output port coupled to the at least one PCIe switch. The device controller is configured to determine a target mode of the at least one PCIe switch based on a performance metric of each of the one or more PCIe devices. The PCIe controller is configured to: receive a control signal indicative of the target mode of the at least one PCIe switch from the device controller, and based on the control signal, output a configuration signal indicative of the target mode to the at least one PCIe switch to set a mode of the at least one PCIe switch to be the target mode.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following benefits, effect and/or advantages. For example, the techniques described in the present disclosure enable a dynamic switching of one or more PCIe switches to accommodate different computational task requirements. The computational task requirements can be associated with performance metrics of the PCIe devices, e.g., power consumption, device utilization, and/or temperature. Based on the performance metrics of the PCIe devices, a host system according to one or more implementations of the present disclosure can be configured to determine a target mode for the PCIe device to meet computational task requirement (e.g., latency, bandwidth), and dynamically switch an operation mode of the PCIe switch to be the target mode. By dynamically switching between different operation modes of the PCIe switch, the techniques can improve resource allocation in the host system and avoid or reduce overload or bandwidth wastage. Additionally, the dynamic switching can be advantageous in complex environment like data centers or high performance computing (HPC) setups where task requirements may change rapidly. As the dynamic switching can reduce or eliminate the manual intervention from users, operation efficiency can be improved, and time consumption can be reduced. Further, the host system described in the present disclosure can support multiple input signals and task types, making it suitable for applications of varying scale and complexity.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is a block diagram of an example of a host system.

FIG. 1B illustrates a flow chart of an example of a method of dynamically switching between different modes of a PCIe switch of the host system of FIG. 1A.

FIG. 2A illustrates a table with examples of performance metrics of a PCIe device and corresponding thresholds.

FIG. 2B illustrates a flow chart of an example of a method of determining a target mode for the PCIe switch of the host system of FIG. 1A.

FIG. 3 illustrates a table of examples of configuration signals generated by a PCIe controller of the host system of FIG. 1A.

FIG. 4 illustrates a block diagram of an example of a common mode of PCIe switches.

FIG. 5 illustrates a block diagram of an example of a balance mode of PCIe switches.

FIG. 6 illustrates a block diagram of an example of a cascade mode of PCIe switches.

FIG. 7 illustrate a flow chart of an example method of operating a host system.

FIG. 8 is a block diagram illustrating an example architecture of a computing system.

FIG. 9 is a block diagram illustrating an example architecture of a computing device.

Like reference numbers and designations in the various drawings indicate like elements.

### DETAILED DESCRIPTION

The present disclosure describes a host system configured to support general computation tasks, high-performance computing (HPC) applications, deep learning applications, artificial intelligence (AI), and/or high storage capacity in flexible configurations. The host system includes a PCIe switch and is configured to be dynamically switched between different operation modes to meet different task requirement (e.g., latency, bandwidth). The operation modes of the PCIe switch can include a common mode, a balance mode and a cascade mode. The host system can include (i) a device controller configured to determine a target mode of the PCIe switch based on performance metrics of PCIe devices that perform the task and (ii) a PCIe controller configured to set a mode of the PCIe switch to be the target mode. By dynamically switching between different operation modes of the PCIe switch without the need for manual intervention, the resource allocation in the host system and operation efficiency can be improved.

The following detailed description describes systems and techniques for a host system configured to dynamically switch between operation modes of the PCIe switch, including at least the device controller and the PCIe controller, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

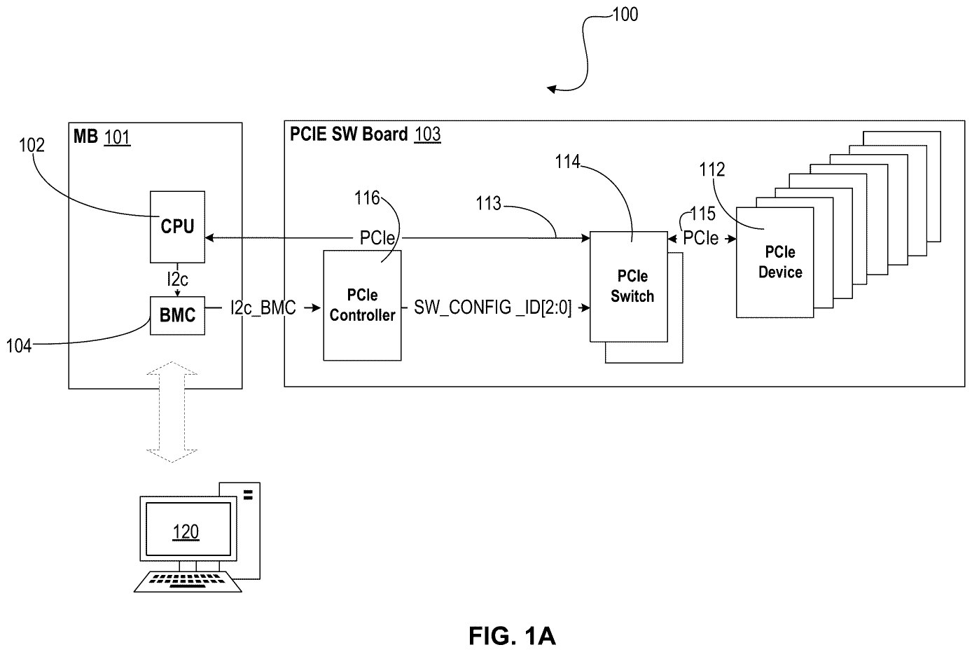

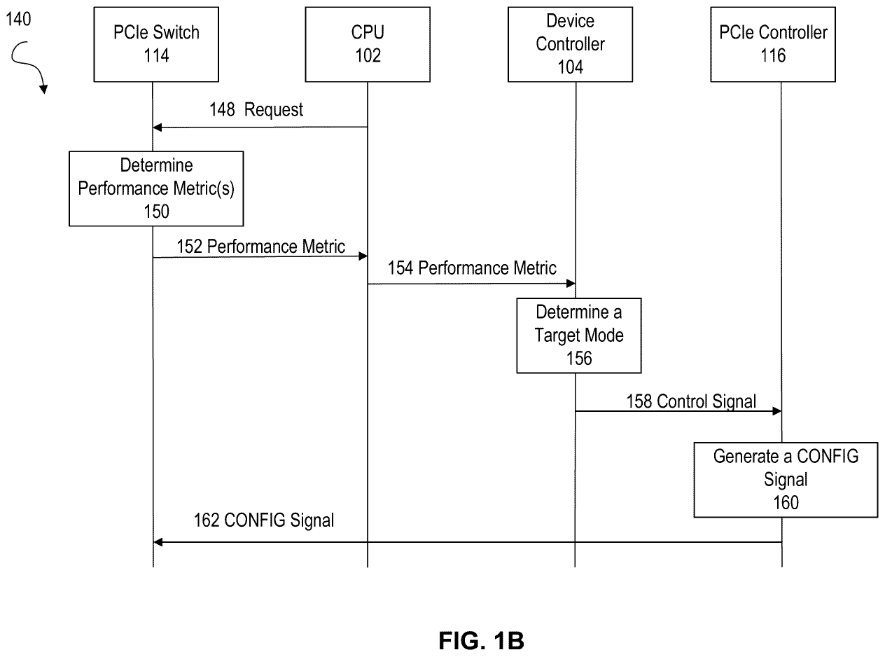

FIG. 1A is a block diagram of an example of a host system 100. For example, the host system 100 can be a computing system (such as a server) or a computing device (such as a computer). The host system 100 can be configured to support high-performance computing (HPC), and/or general computation tasks. The host system 100 includes one or more processing devices 102. The one or more processing devices 102 can include, e.g., one or more central processing units (CPUs), one or more graphics processing units (GPUs), one or more data processing units (DPUs), one or more Application Specific Integrated Circuits (ASICs), one or more Field Programmable Gate Arrays (FPGAs), one or more multi-core processors, one or more microprocessors, one or more quantum processors, or a combination thereof. For example, the host system 100 can include at least one CPU 102.

The host system 100 can include a device controller 104 coupled to the one or more processing devices 102. The device controller 104 can be a baseboard management controller (BMC) configured to monitor various system health parameters, e.g., temperature, fan speeds, power supply voltages, CPU usage, or memory health. In some examples, the device controller 104 can include a microcontroller and one or more sensors. The one or more sensors can include, without limitation to, (i) a temperature sensor configured to monitor the temperature of the one or more processing devices 102 (e.g., CPU), PCIe devices, and/or other components in the host system 100, (ii) a voltage sensor configured to monitor power supply levels, (iii) a fan sensor configured to monitor fan speed and airflow; (iv) a memory fault sensor configured to detect faults in memory devices or memory controllers, and/or (v) a power sensor configured to monitor the health of the power supply (e.g., whether the power levels are within the required range).

The device controller 104 can be configured to communicate with the processing devices 102 through inter-integrated circuit (I2C) communication protocol. In some examples, the combination of the one or more processing devices 102 and the device controller 104 can be referred to as a motherboard 101 or as a host device 101.

The host system 100 can include one or more PCIe devices 112 and at least one PCIe switch 114 correspondingly coupled to the one or more PCIe devices 112. In some implementations, the one or more PCIe devices 112 include at least one of one or more Graphics Processing Units (GPUs), one or more storage devices, one or more network devices, one or more sound devices, one or more capture devices, or one or more expansion devices.

A PCIe switch 114 can be configured to manage and route data between multiple PCIe devices 112 and the one or more processing devices 102. For example, the PCIe switch 114 can be configured to distribute bandwidth among the connected PCIe devices 112. In some implementations, each of the at least one PCIe switch 114 includes an upstream port 113 and one or more downstream ports 115. The upstream port 113 is coupled to a processing device 102, and the one or more downstream ports 115 are correspondingly coupled to the one or more PCIe devices 112. For example, as illustrated in FIG. 1A, the host system 100 can include two PCIe switches 114, and each PCIe switch 114 can include four or more downstream ports 115. Therefore, the two PCIe switches 114 can be coupled to a total number of eight PCIe devices 112. As described below in greater details, the PCIe switches 114 can work in different operation modes, e.g., a common mode, a balance mode, or a cascade mode, for accommodating different workload and/or task requirements.

The host system 100 can additionally include a PCIe controller 116 configured to control an operation mode of at least one PCIe switch 114 based on a control signal from the device controller 104. In some implementations, the PCIe controller 116 includes a first input port coupled to the device controller 104 and at least one output port coupled to the at least one PCIe switch 114. In some implementations, the PCIe controller 116 is a complex programmable logic device (CPLD), a programmable array logic (PAL), a general array logic (GAL), or a field-programmable gate arrays (FPGA). In some implementations, the one or more PCIe devices 112, the at least one PCIe switch 114, and the PCIe controller 116 are integrated in a same circuit board 103.

As noted above, the PCIe switches 114 can operate in different modes, e.g., the common mode, the balance mode, or the cascade mode. Different devices in the host system 100 may have varying bandwidth and latency requirements, and different tasks (e.g., computational tasks) may require varying levels of bandwidth or resource allocation. Therefore, dynamically switching between different modes of the PCIe switch 114 to accommodate different tasks may be advantageous, as it can provide a better performance, resource allocation, and scalability. For example, the common mode can be used to perform low complexity tasks (e.g., inference task which requires lower computational power and bandwidth compared to training). The balance mode can be used to perform moderate complexity tasks (e.g., a training task). The cascade mode can be used to perform high complexity tasks (e.g., performing both inference and training simultaneously, which may require scalability and high-speed interconnects). The host system 100 disclosed in the present disclosure can be configured to dynamically switch between different modes of the PCIe switch 114 to improve the system performance. The example methods of dynamically switching between different modes of the PCIe switch 114 are described below in reference to FIGS. 1B-3.

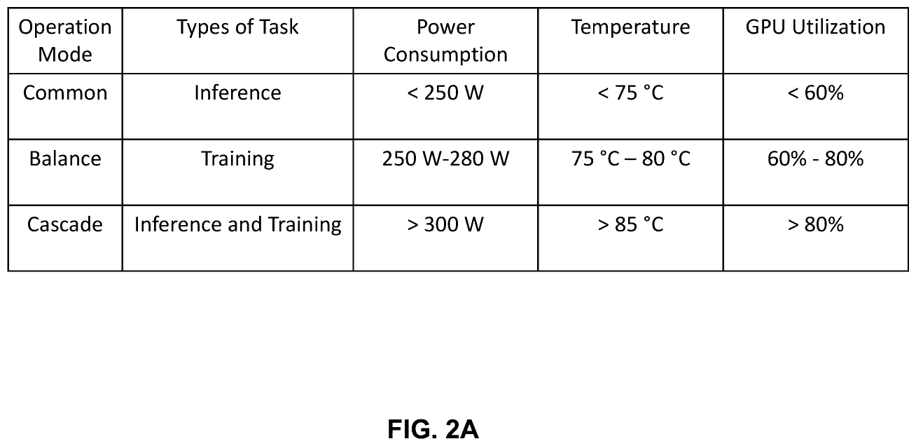

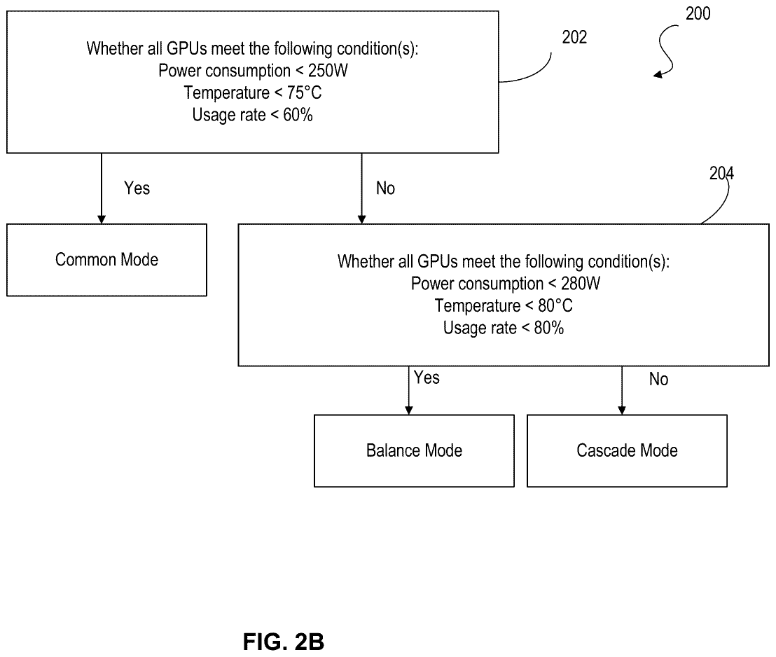

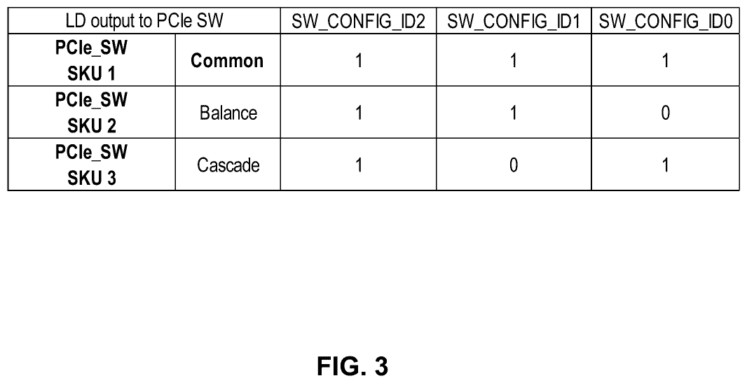

FIG. 1B illustrates a flow chart of an example of a method of dynamically switching between different modes of a PCIe switch 114. FIG. 2A illustrates a table with examples of performance metrics of a PCIe device 112 and corresponding thresholds for a common mode, a balance mode and a cascade mode. FIG. 2B illustrates a flow chart of an example of a method of determining a target mode for the PCIe switch 114. FIG. 3 illustrates a table of examples of configuration signals generated by the PCIe controller 116. For ease of description, reference will be made to FIGS. 1B-3 when describing the operations of the host system 100 for dynamically switching between different modes of a PCIe switch 114.

Referring to FIG. 1B, at step 148, the one or more processing devices 102 (e.g., CPU) can be configured to send a request for checking a current performance metric of each of the one or more PCIe devices 112 to the at least one PCIe switch 114. The performance metric can include at least one of a device utilization, a power consumption, a temperature, a speed of fan, or a power supply current. The performance metric can be associated with task requirements. For example, for high complexity tasks, a higher device utilization, a higher power consumption and/or a higher temperature may be present in the PCIe device that performs the tasks. Correspondingly, the speed of fan may also be higher for cooling down the PCIe device. Therefore, current performance metric of a PCIe device may provide information about the types or complexity of tasks that the PCIe device is performing.

In some implementations, the one or more processing devices 102 (e.g., CPU) can be configured to send the request in response to an event. The event can include, without limitation to, (i) a request from the device controller 104 to the CPU 102 for checking the performance metric of the one or more PCIe devices 112; (ii) a thermal threshold being exceeded (e.g., GPU temperature exceeds 85° C.); (iii) power consumption anomaly (e.g., GPU power consumption spikes above a certain limit); (iv) a device failure/error (e.g., GPU core error, device disconnection); (v) device hot plug/unplug (e.g., inserting or removing a PCIe device 112); (vi) performance degradation (e.g., GPU utilization drops significantly over a short time period), or (vii) frequent mode switching anomaly (e.g., PCIe switch 114 repeatedly toggling between common, balance, cascade modes in a short time).

In some implementations, instead of being event-triggered, the one or more processing devices 102 are configured to periodically send the request for checking the current performance metric of each of the one or more PCIe devices 112 to the at least one PCIe switch 114. For example, the one or more processing devices 102 can be configured to send the request every 1 s, 30 s, 1 min, 5 mins, 30 mins, 1 hour, 2 hours, or 5 hours, etc.

At step 150, the at least one PCIe switch 114 can be configured to, in response to the request, determine the performance metric of each of the one or more PCIe devices 112. For example, the at least one PCIe switch 114 can determine the device utilization by monitoring data traffic flow (or bandwidth usage), and/or determine the power consumption of the PCIe device by using a power sensor or through PCIe switch management interface.

In some implementations, the PCIe switch 114 is configured to determine the performance metric for all PCIe devices 112 that are coupled to it. In some implementations, the PCIe switch 114 is configured to determine the performance metric for selected PCIe devices 112. For example, a PCIe switch 114 can be coupled to GPUs and storage devices. Instead of determining the performance metrics for all GPUs and storage devices, the PCIe switch can determine the performance metrics for GPUs only, as GPUs may have higher bandwidth requirements and thereby a greater influence on determining the target mode for the PCIe switch.

At step 152, the PCIe switch 114 can be configured to transmit the performance metric of the one or more PCIe devices 112 to the processing device 102, e.g., through the upstream port 113 of the PCIe switch 114. In some implementations, the at least one PCIe switch 114 is configured to transmit the performance metric of the PCIe devices 112 to the one or more processing devices 102 based on a PCIe communication protocol and/or a compute express link (CXL) protocol.

At step 154, the one or more processing devices 102 can be configured to transmit the performance metric of the one or more PCIe devices 112 to the device controller 104. In some implementations, the one or more processing devices 102 is configured to transmit the performance metric according to a communication protocol based on one of inter-integrated circuit (I2C), serial peripheral interface (SPI), system management bus (SMBus), or universal asynchronous receiver-transmitter (UART).

In some implementations, rather than relying on the processing device 102 to provide all performance metrics, the device controller 104 can determine at least one of the performance metrics of the PCIe devices 112 using the sensors. As noted above, the device controller 104 can include at least one sensor. Therefore, in some examples, the device controller 104 can determine temperature using its temperature sensor, and/or determine the speed of fan using its fan sensor. The device controller can then receive other performance metrics (e.g., device utilization) form the processing device 102.

At step 156, the device controller 104 can be configured to determine a target mode of the at least one PCIe switch 114 based on the performance metric of each of the one or more PCIe devices 112. In some implementations, for determining the target mode of the at least one PCIe switch 114, the device controller 104 is configured to compare the performance metric of each of the one or more PCIe devices 112 with at least one of a first threshold or a second threshold, and the second threshold is greater than the first threshold. Referring to FIG. 2A, in some examples, the first threshold for the power consumption can be 250 W, while the second threshold for the power consumption can be 280 W. The first threshold for the temperature can be 75° C., while the second threshold for the temperature can be 80° C. The first threshold for the GPU utilization can be 60%, while the second threshold for the GPU utilization can be 80%. The device controller 104 can compare the performance metric of each PCIe device 112 with corresponding thresholds. For example, the device controller 104 can compare the power consumption of each PCIe device 112 with the power consumption thresholds, compare the temperature of each PCIe device 112 with the temperature threshold, and/or compare the device utilization of each PCIe device 112 with the device utilization threshold.

Referring now to FIG. 2B, in some implementations, in response to determining that the performance metric of each of the one or more PCIe devices 112 is below the first threshold, the device is configured to determine the target mode of the at least one PCIe switch 114 to be a first mode (e.g., the common mode). In response to determining that the performance metric of at least one of the one or more PCIe devices 112 is above the first threshold and the performance metric of each of the one or more PCIe devices 112 is below the second threshold, the device controller 104 is configured to determine the target mode of the at least one PCIe switch 114 to be a second mode (e.g., the balance mode). In response to determining that the performance metric of at least one of the one or more PCIe devices 112 is above the second threshold, the device controller 104 is configured to determine the target mode of the at least one PCIe switch 114 to be a third mode (e.g., the cascade mode). The determination method 200 is explained and described below in two examples:

Example One: the PCIe devices 112 are GPUs, and the performance metric are power consumption.

In operation 202, the device controller 104 can compare the power consumption value of each GPU with the first threshold of the power consumption (e.g., 250 W) and determine whether all GPUs have the power consumption values lower than the first threshold. If all GPUs meet this first condition (e.g., having the power consumption values below the first threshold), the device controller 104 can determine the target mode for the PCIe switch 114 is the common mode. If any GPU fails to meet the first condition (in other words, at least one GPU has the power consumption value above the first threshold), the device controller 104 can proceed to operation 204.

In operation 204, the device controller 104 can compare the power consumption value of each GPU with the second threshold (e.g., 280 W) and determine whether all GPUs have the power consumption below the second threshold. If all GPUs meet this second condition (e.g., having the power consumption values below the second threshold), the device controller 104 can determine the target mode for the PCIe switch 114 to be the balance mode. If any GPU does not meet condition (in other words, at least one PCIe device 112 is above the second threshold), the device controller 104 can determine the target mode for the PCIe switch 114 is the cascade mode.

Example Two: the PCIe devices 112 are GPUs, and the performance metrics are power consumption and temperature.

In operation 202, the device controller 104 can compare the power consumption value of each GPU with the first threshold of the power consumption (e.g., 250 W) and compare the temperature of each GPU with the first threshold of temperature (e.g., 75° C.). Based on the comparison result, the device controller 104 can determine whether all GPUs have both the power consumption values and temperature values lower than the corresponding first thresholds. If all GPUs meet this first condition, the device controller 104 can determine the target mode for the PCIe switch 114 is the common mode.

Determining whether all GPUs meet the first condition can be based on either one of the performance metrics or both performance metrics. In some implementations, determining whether all GPUs meet the first condition is based on either one of the performance metrics. In other words, if any GPU fails to meet any threshold, the device controller 104 can determine that the first condition is not met. For example, if a GPU has the power consumption value smaller than 250 W but its temperature value exceeds 75° C., the device controller 104 can determine that the first condition is not met.

In some implementations, determining whether all GPUs meet the first condition can be based on both performance metrics. In other words, if a GPU fails to meet both thresholds, the device controller 104 can determine that the first condition is not met. For example, if a GPU has the power consumption value greater than 250 W and the temperature value greater than 75° C., the device controller 104 can determine that the first condition is not met. On the other hand, if the GPU has the power consumption value smaller than 250 W but its temperature value exceeds 75° C., the device controller 104 can determine that this GPU meets the first condition.

If any GPU fails to meet the first condition, the device controller 104 can proceed to operation 204. In operation 204, the device controller 104 can compare the power consumption value and temperature value of each GPU with corresponding second thresholds (e.g., 280 W for power consumption, 75° C. for temperature) and determine whether all GPUs meet a second condition. If all GPUs meet this second condition, the device controller 104 can determine the target mode for the PCIe switch 114 to be the balance mode. If any GPU fails to meet the second condition, the device controller 104 can determine the target mode for the PCIe switch 114 is the cascade mode. Similar to determining whether any GPU fails to meet the first condition, determining whether any GPU fails to meet the second condition can depend on either one of performance metrics or both performance metrics.

While the method 200 shown in FIG. 2B has been described as first comparing the against first threshold (e.g., operation 202) followed by comparing against the second threshold (e.g., operation 204), in some implementations, the device controller 104 can be configured to perform these operations in a reverse order, e.g., comparing first against the second threshold and then against the first threshold. For example, in the first operation, the device controller compares the performance metrics against corresponding second thresholds. If the device controller 104 determines that the performance metric of at least one of the PCIe devices 112 is above the second threshold, the device controller 104 can determine the target mode to be the cascade mode. Otherwise, the device controller 104 can proceed to the next operation to compare the performance metrics against the first threshold. If the device controller 104 determines that the performance metrics of all PCIe devices 112 are below the first threshold, the device controller 104 can determine the target mode to be the common mode. Otherwise, the device controller 104 can determine that the target mode is the balance mode.

While the method 200 shown in FIG. 2B has been described as having two separate operations for respectively comparing against the first and second thresholds, in some implementations, the device controller 104 can be configured to perform the comparison against both thresholds in a same operation for each PCIe device. For example, the device controller 104 can be configured to sequentially compare the performance metrics of each PCIe device 112 against both thresholds, starting with the first PCIe device (the performance metric of which is compared against both thresholds), then the second PCIe device (the performance metric of which is also compared against both thresholds), followed by the third, and so on. Based on the comparison results for all PCIe deices against both thresholds, the device controller 104 can then determine the target mode to be one of the common mode, balance mode, or cascade mode.

While the PCIe devices 112 in the example implementations described above in reference to FIG. 2B are all GPUs, in some implementations, the PCIe devices 112 can include different types of devices. For example, the PCIe devices 112 can include 4 GPUs and 1 storage device. In some implementations, different PCIe devices 112 have different thresholds for a same performance metric. For example, the first threshold for GPU power consumption can be 250 W, while the first threshold for the power consumption of the storage device can be 200 W. The device controller 104 can be configured to compare performance metric of each PCIe device 112 against its corresponding threshold. For example, the device controller 104 can compare the power consumption of a GPU against 250 W, while comparing the power consumption of the storage device against 200 W.

While the device controller 104 has been described as determining a same target mode for all PCIe switches 114, in some implementations, the device controller 104 can be configured to determine different target modes for different PCIe switches 114. For example, the host system 100 can include four PCIe switches #1-#4. The device controller 104 can be configured to determine the target mode for two PCIe switches #1, #2 to be the common mode, while the target mode for the other two PCIe switches #3, #4 to be the balance mode. For determining the target mode separately for different PCIe switches 114, the device controller 104 can be configured to group the PCIe devices 112 based on the corresponding PCIe switches 114. For example, to determine the target mode for the PCIe switches #1, #2 together, the device controller 104 can group the PCIe devices 112 that are coupled to the PCIe switches #1, #2 as a first group and perform the method 200 as described above on the first group of the PCIe devices 112 to determine the target mode for the PCIe switches #1, #2. Then, the device controller 104 can group the PCIe devices 112 that are coupled to the PCIe switches #3, #4 as a second group and perform the method 200 on the second group of the PCIe devices 112 to determine the target mode for the PCIe switches #3, #4. In some implementations, the grouping of PCIe switches 114 or PCIe devices 112 can be based on the PCIe device types and/or task requirements.

While the device controller 104 has been described (e.g., in reference to FIG. 2B) as determining the cascade mode based on performance metrics of at least one PCIe device 112 being above the second threshold, in some implementations, the device controller 104 is configured to (i) compare the performance metrics of at least one of the PCIe devices 112 against a third threshold that is greater than the second threshold, and (ii) determine the target mode for the PCIe switch 114 to be the cascade mode based on performance metrics of at least one of the PCIe devices 112 being above the third threshold. For example, returning to FIG. 2A, in some examples, the third threshold for power consumption is 300 W for GPU, which is greater than the second threshold 280 W. Based on the power consumption of the at least one GPU being above 300 W, the device controller 104 can determine the target mode for the PCIe switch 114 is the cascade mode. In another example, the third threshold for temperature is 85° C., which is greater than the second threshold 80° C. Based on the temperature of the at least one GPU being above 85° C., the device controller 104 can determine the target mode for the PCIe switch 114 is the cascade mode.

In some implementations, based on the performance metrics of all PCIe devices 112 being between the second threshold and the third threshold, the device controller 104 can be configured to determine the target mode for the PCIe switch 114 being its current mode. For example, if all GPUs have the power consumption between 280 W and 300 W, and the current mode of the PCIe switch 114 is the balance mode, the device controller 104 can determine that the target mode for the PCIe switch 114 is the balance mode. In other words, the PCIe switch 14 will be controlled to maintain the balance mode. In another example, if all GPUs have the temperature between 80° C. and 85° C., and the current mode of the PCIe switch 114 is the cascade mode, the device controller 104 can determine that the target mode for the PCIe switch 114 is the cascade mode. In other words, the PCIe switch 14 will be controlled to maintain the cascade mode.

With continued reference to FIG. 2A, as noted above, different computational tasks (e.g., inference and/or training) may have different computational requirements. Training tasks may require more computational power and higher GPU utilization than inference tasks. Accordingly, the GPU temperature associated with training tasks may be higher. Therefore, by comparing the performance metrics of GPU with different thresholds, the device controller 104 can be configured to determine which operation the GPU is likely performing.

In some implementations, the device controller 104 is configured to: (i) in response to the performance metric of each of the one or more PCIe devices 112 being below the first threshold, determine that the one or more PCIe devices 112 are likely performing an interference operation; (ii) in response to the performance metric of at least one of the one or more PCIe devices 112 being above the first threshold and the performance metric of each of the one or more PCIe devices 112 being below the second threshold, determine that the one or more PCIe devices 112 are likely performing a training operation; and (iii) in response to the performance metric of at least one of the one or more PCIe devices 112 being above the second threshold, determine the one or more PCIe devices 112 are likely performing both interference and training operations. For example, as illustrated in FIG. 2A, if the device controller 104 determines that the power consumption for a GPU is below 250 W, the device controller 104 can determine the GPU is performing an inference operation. In another example, if the device controller 104 determines that the temperature of a GPU is between 75° C. and 80° C., the device controller 104 can determine that the GPU is performing a training operation.

In some implementations, the device controller 104 is configured to determine both the target mode for the PCIe switches 114 (e.g., the common mode, the balance mode and/or the cascade mode) and the task type (e.g., inference and/or training) at one or more same operation steps (e.g., the operation steps 202 and 204 in FIG. 2B). For example, as illustrated in FIG. 2A, if the device controller 104 determines that the power consumption for all GPUs is lower than 250 W, the device controller 104 can determine that the GPUs are performing the inference operation and that the target mode for the corresponding PCIe switch 114 is the common mode.

It is to be understood that the performance metrics and the first, second, and/or third threshold values in FIGS. 2A and 2B are for illustration purpose and not intended to be construed in a limiting sense. Other performance metrics and thresholds values are also possible.

Returning to FIG. 1B, after the device controller 104 determines the target mode for the PCIe switch 114, at step 158, the device controller 104 is configured to (i) generate a control signal based on the target mode of the PCIe switch 114 and (ii) transmit the control signal indicative of the target mode to the PCIe controller 116. In some implementations, the device controller 104 is configured to transmit the control signal according to a communication protocol based on one of inter-integrated circuit (I2C), serial peripheral interface (SPI), system management bus (SMBus), or universal asynchronous receiver-transmitter (UART).

At step 160, the PCIe controller 116 can be configured to (i) receive the control signal indicative of the target mode of the at least one PCIe switch 114 from the device controller 104, and (ii) based on the control signal, generate a configuration signal indicative of the target mode. Referring now to FIG. 3, the configuration signal can include a three-bit binary value. For example, the configuration signal for the common model is 111, the configuration signal for the balance mode is 110, and the configuration signal for the cascade mode is 101. In some implementations, the PCIe controller 116 includes three general purpose input/output (GPIO) pins, and the PCIe controller 116 is configured to transmit the configuration signal through the GPIO pins, e.g., with each GPIO pin transmitting one bit of the configuration signal. It is to be understood that examples of configuration signals in the FIG. 3 is for illustration purpose, and not intended to be construed in a limiting sense. The configuration signals can include any other number of binary bits, e.g., 2, 4, 5, 6, or 7. The PCIe controller 116 can include any other number of GPIO pins, e.g., 2, 4, 5, 6, or 7. In addition, the configuration signal for the common mode, the balance mode, or the cascade mode can be any sequence of binary values other than the examples shown in FIG. 3.

Returning to FIG. 1B, at step 162, the PCIe controller 116 can be configured to transmit the configuration signal to the at least one PCIe switch 114 to set a mode of the at least one PCIe switch 114 to be the target mode. Accordingly, dynamically switching the mode of the PCIe switch 114 can be achieved, e.g., based on task requirements and/or task types being performed by the PCIe devices 112.

While the method 140 illustrated in FIG. 1B has been described as using the device controller 104 to determine the target mode of the at least one PCIe switch 114, in some implementations, the target mode of the at least one PCIe switch 114 is configured to be determined by a trained model on a remote computing device. Returning to FIG. 1A, in some implementations, the host system 100 is configured to transmit the performance metric of each of one or more PCIe devices 112 to the remote computing device 120 to determine the target mode. The trained model on the remote computing device 120 can be configured to determine the target mode based on the performance metric of at least one of one or more PCIe devices 112. The host system 100 can be then configured to receive a signal indicative of the target mode of the at least one PCIe switch 114 from the remote computing device 120. In some implementations, the model on the remote computing device 120 can be trained by historical performance metrics as input features and target modes of the PCIe switch 114 as output. The model can be based on logistic regression, random forest, neural network, support vector machines, or any other suitable model. The remote computing device 120 can include one or more processors (e.g., CPUs) and a computer-readable medium (e.g., a non-transitory computer-readable medium) storing computer instructions associated with the trained model that are executable by the one or more processors. The remote computing device 120 can communicate wirelessly with the host system 100. In some examples, the remote computing device 120 can be configured to communicate with the device controller 104 of the host system 100.

In some implementations, the trained model is configured to (i) update at least one of the first threshold or the second threshold based on the performance metric of each of one or more PCIe devices 112, and (ii) determine the target mode of the at least one PCIe switch 114 based on at least one of the updated first threshold or the updated second threshold. For example, the trained model can be configured to update the first and/or second threshold based on a baseline performance metrics of the PCIe devices 112 that are collected over a period of time (e.g., 1 day, 7 days, 1 month, or 3 months). If the baseline performance metrics of PCIe devices 112 have remained below the first threshold (and thereby dynamically switching of PCIe switch modes has not been triggered during this period), the trained model can be configured to lower the first threshold to leverage the dynamic switching capabilities of the host system 100.

In some implementations, rather than determining the target mode of the PCIe switch 114, the trained model can be configured to (i) update at least one of the first, second and/or third thresholds based on the performance metric of at least one of one or more PCIe devices 112 and (ii) then transmit the updated thresholds to the device controller 104. The device controller 104 can be configured to determine the target mode of the at least one PCIe switch 114 based on at least one updated threshold.

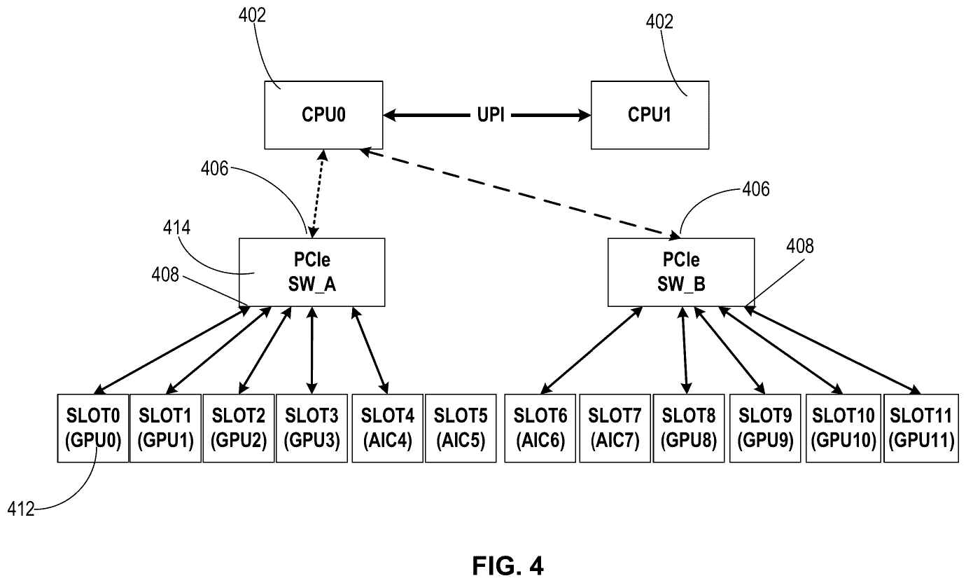

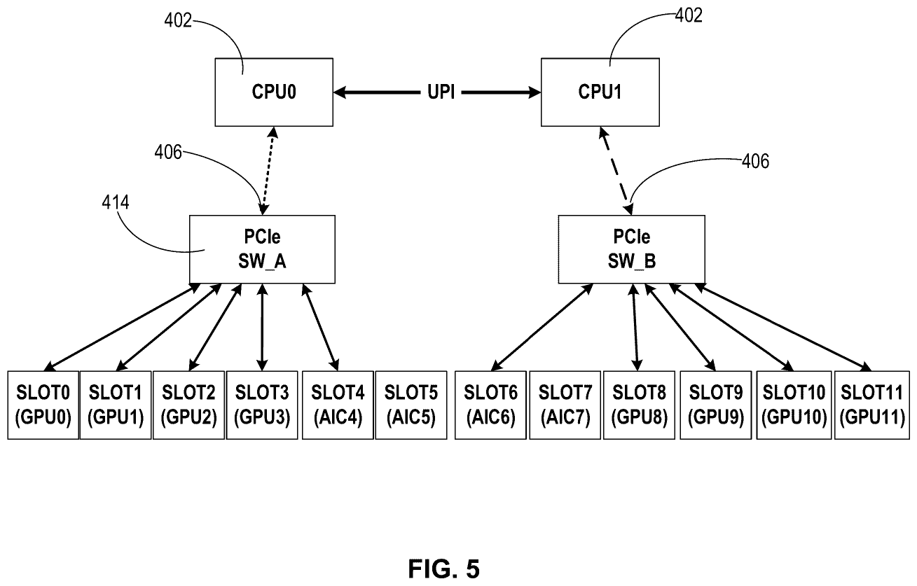

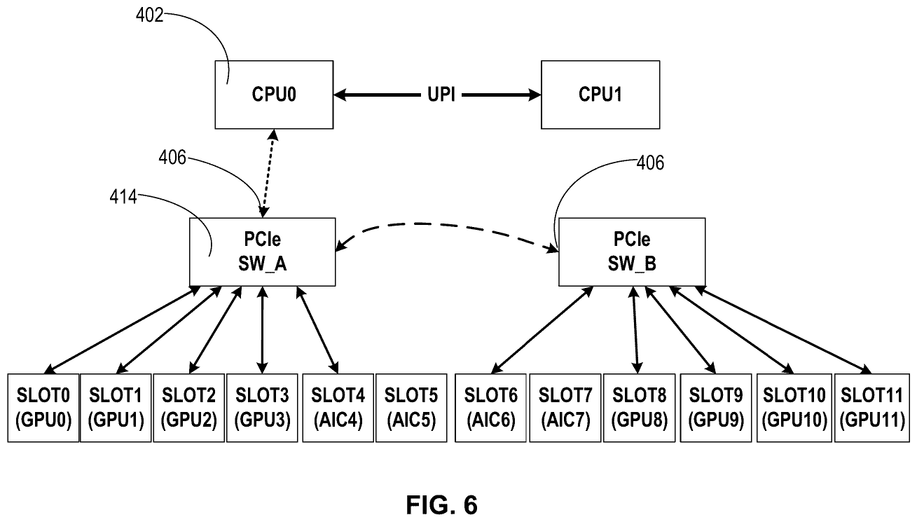

FIG. 4 illustrates a block diagram of an example of the common mode of PCIe switches 114. FIG. 5 illustrates a block diagram of an example of the balance mode of PCIe switches 114. FIG. 6 illustrates a block diagram of an example of the cascade mode of PCIe switches 114. In some implementations, referring to FIGS. 4-6, the at least one PCIe switch 114 includes a primary PCIe switch SW_A and one or more secondary PCIe switches SW_B (e.g., one secondary PCIe switch 414 is shown in FIGS. 4-6). The PCIe switches SW_A, SW_B can be the PCIe switches 114 of FIG. 1A. Each PCIe switch includes an upstream port 406 (e.g., upstream port 113 of FIG. 1A) and one or more downstream ports 408 (e.g., downstream port 115 of FIG. 1A). The one or more downstream ports 408 can be correspondingly coupled to the one or more PCIe devices 412 (e.g., PCIe devices 112 of FIG. 1A). For example, as illustrated in FIGS. 4-6, the primary PCIe switch SW_A can include at least five downstream ports 408, with four respectively coupled to four GPUs (e.g., GPU0, GPU1, GPU2, GPU3) and one coupled to a storage card (e.g., ACI4). Although not show, the primary PCIe switch SW_A can include a sixth downstream port 408 that is coupled to a network card (e.g., AIC5). Similarly, the secondary PCIe switch SW_B can include at least five downstream ports 408, with four respectively coupled to four GPUs (e.g., GPU8, GPU9, GPU10, GPU11) and one coupled to a storage card (e.g., ACI6). Although not shown, the secondary PCIe switch SW_B can also include a sixth downstream port 408 that is coupled to a network card (e.g., AIC7). It is to be noted that despite the terms “primary” and “secondary,” the primary PCIe switch SW_A and the secondary PCIe switches SW_B can have the same structure and configuration.

As illustrated in FIG. 4, in the common mode, the upstream port 406 of each of the at least one PCIe switch 414 is coupled to a same processing device 402 of a plurality of processing devices 402 (e.g., processing device 102 of FIG. 1A). For example, the example implementation shown in FIG. 4 has two processing devices 402 (e.g., CPU0, CPU1). The upstream ports 406 of both PCIe switches SW_A, SW_B are coupled to the same CPU0. Without being limited to any particular theory, the PCIe switches in the common mode can dynamically allocate bandwidth based on PCIe device requirement and/or demand. In some implementations, the one or more processing devices 402 can communicate with one another, e.g., based on Ultra Path Interconnect (UPI) protocol.

As illustrated in FIG. 5, in the balance mode, the upstream port 406 of each of the at least one PCIe switch 414 is coupled to a respective processing device 402 of the plurality of processing devices 402. For example, the primary PCIe switch SW_A can be coupled to a first processing device CPU0, while the secondary PCIe switch SW_B can be coupled to a second processing device CPU1. Without being limited to any particular theory, the PCIe switches in the balance mode have a fixed, equal distribution of PCIe lanes.

As illustrated in FIG. 6, in the cascade mode, the upstream port 406 of the primary PCIe switch SW_A is coupled to a processing device 402 of the plurality of processing devices 402, and the upstream port 406 of one or more secondary PCIe switches 414 is coupled to the primary PCIe switch SW_A in a cascade configuration. For example, the primary PCIe switch SW_A can be coupled to the processing device CPU0, while the secondary PCIe switch SW_B can be coupled to the primary PCIe switch SW_A to form a cascade configuration (e.g., multiple PCIe switches 414 are connected in series). Without being limited to any particular theory, the PCIe switches in the cascade mode can enable scalability and allow integration of more PCIe devices.

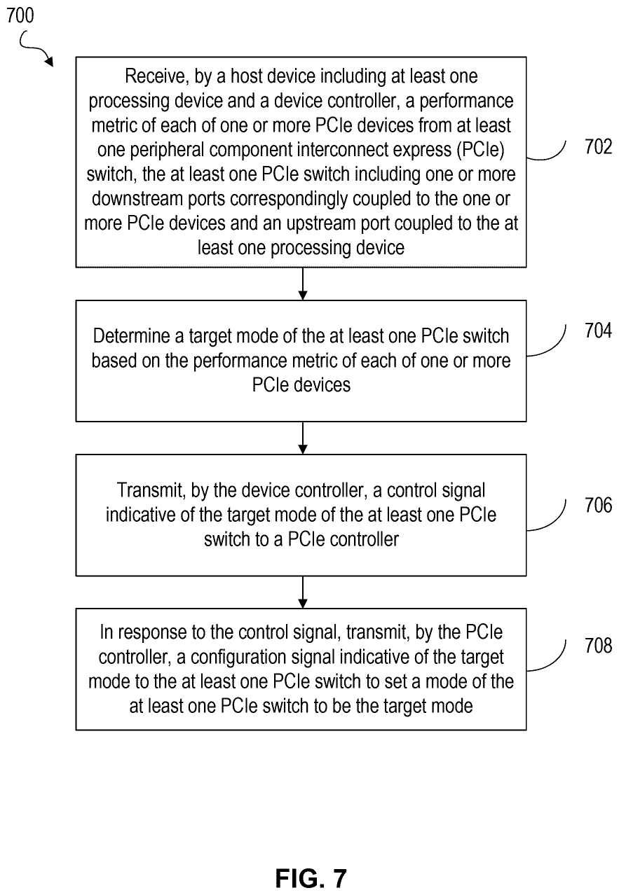

FIG. 7 illustrate a flow chart of an example of a method 700 of operating a host system. The host system can be the host system 100 of FIG. 1A.

At step 702, a performance metric of each of one or more PCIe devices is received, by a host device including at least one processing device and a device controller, from at least one peripheral component interconnect express (PCIe) switch. The at least one PCIe switch includes one or more downstream ports correspondingly coupled to the one or more PCIe devices and an upstream port coupled to the at least one processing device. The PCIe devices can be, e.g., the PCIe devices 112 of FIG. 1A, or PCIe devices 412 of FIGS. 4-6. The host device can be, e.g., the host device 101 of FIG. 1A. The processing device can be, e.g., the processing device 102 of FIGS. 1A-1B, or the processing device 402 of FIGS. 4-6. The device controller can be, e.g., the device controller 104 of FIGS. 1A-1B. The PCIe switch can be, e.g., the PCIe switch 114 of FIGS. 1A-1B, or the PCIe switch 414 of FIGS. 4-6. The downstream ports can be, e.g., the downstream ports 115 of FIG. 1A, or the downstream ports 408 of FIGS. 4-6. The upstream port can be, e.g., the upstream port 113 of FIG. 1A, or the upstream port 406 of FIGS. 4-6.

At step 704, a target mode of the at least one PCIe switch is determined based on the performance metric of each of one or more PCIe devices, as described above in reference to FIGS. 1A-6.

At step 706, a control signal indicative of the target mode of the at least one PCIe switch is transmitted by the device controller to a PCIe controller. The PCIe controller can be, e.g., the PCIe controller 116 of FIGS. 1A-1B.

At step 708, in response to the control signal, a configuration signal indicative of the target mode is transmitted by the PCIe controller to the at least one PCIe switch to set a mode of the at least one PCIe switch to be the target mode, as described above in reference to FIGS. 1A-6.

In some implementations, determining the target mode of the at least one PCIe switch includes: comparing the performance metric of each of the one or more PCIe devices with at least one of a first threshold or a second threshold, the second threshold being greater than the first threshold; and determining the target mode of the at least one PCIe switch based on a result of the comparing, the determining including one of: in response to the performance metric of each of the one or more PCIe devices being below the first threshold, determining the target mode of the at least one PCIe switch to be a first mode; in response to the performance metric of at least one of the one or more PCIe devices being above the first threshold and the performance metric of each of the one or more PCIe devices being below the second threshold, determining the target mode of the at least one PCIe switch to be a second mode; or in response to the performance metric of at least one of the one or more PCIe devices being above the second threshold, determining the target mode of the at least one PCIe switch to be a third mode, as described above in reference to FIGS. 1B-2B.

In some implementations, determining the target mode of the at least one PCIe switch includes: determining the target mode of the at least one PCIe switch by the device controller.

In some implementations, determining the target mode of the at least one PCIe switch includes: determining the target mode of the at least one PCIe switch by a trained model on a remote computing device, and where the method includes: transmitting, by the host device, the performance metric of each of one or more PCIe devices to the remote computing device to determine the target mode to the remote computing device; and receiving, by the host device, a signal indicative of the target mode of the at least one PCIe switch from the remote computing device. The remote computing device can be, e.g., the remote computing device 120 of FIG. 1A.

In some implementations, the method 700 includes updating, by a trained model on a remote computing device, at least one of the first threshold or the second threshold based on the performance metric of each of one or more PCIe devices, as described above in reference to FIGS. 1A-6. In some implementations, the method includes determining another target mode of the at least one PCIe switch based on at least one of the updated first threshold or the updated second threshold.

In some implementations, the performance metric includes at least one of a device utilization, a power consumption, a temperature, a speed of fan, or a power supply current.

In some implementations, the method 700 includes in response to an event, sending, by the at least one processing device of the host device, a request for checking a current performance metric of each of the one or more PCIe devices to the at least one PCIe switch; and in response to the request, determining, by the at least one PCIe switch, the performance metric of each of the one or more PCIe devices, as described above in reference to FIGS. 1A-1B.

In some implementations, the method 700 includes periodically sending, by the at least one processing device of the host device, a request for checking a current performance metric of each of the one or more PCIe devices to the at least one PCIe switch; and in response to the request, determining, by the at least one PCIe switch, the performance metric of each of the one or more PCIe devices, as described above in reference to FIGS. 1A-1B.

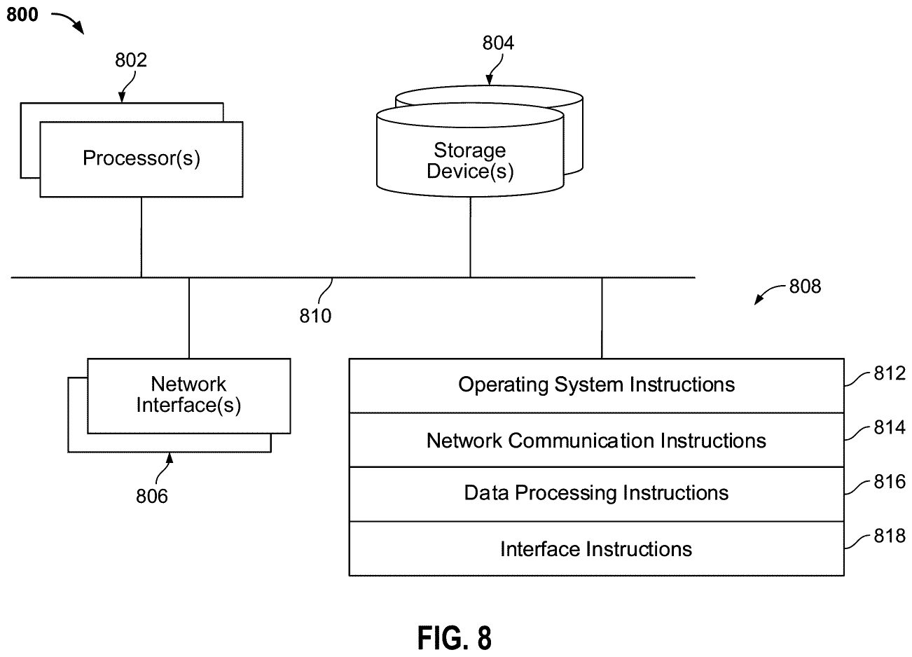

FIG. 8 is a block diagram illustrating an example architecture 800 of a computing system used to provide computational functionalities associated with described algorithms, methods, functions, processes, flows, and procedures. The computing system can be implemented as the host system 100 of FIG. 1A. Other architectures are possible, including architectures with more or fewer components.

In some implementations, architecture 800 includes one or more processor(s) 802 (e.g., dual-core Intel® Xeon® Processors), one or more network interface(s) 806, one or more storage device(s) 804 (e.g., hard disk, optical disk, flash memory) and one or more computer-readable medium(s) 808 (e.g., hard disk, optical disk, flash memory, etc.). These components can exchange communications and data over one or more communication channel(s) 810 (e.g., buses), which can utilize various hardware and software for facilitating the transfer of data and control signals between components.

The computing system can, for example, use a PCIe switch between the processors 802 and storage devices 804, where the processors 802 can be host devices and the storage devices can be PCIe devices. In some examples, the computing system can use a PCIe switch between processors 802, e.g., CPUs and GPUs, where the CPUs can be host devices and GPUs can be PCIe devices. In some other examples, the computing system can use a PCIe switch between processors 802 and network interfaces 806, where the processors can be host devices and the network interfaces 806 can be PCIe devices.

The term “computer-readable medium” refers to any medium that participates in providing instructions to the processor(s) 802 for execution, including without limitation, non-volatile media (e.g., optical or magnetic disks), volatile media (e.g., memory) and transmission media. Transmission media includes, without limitation, coaxial cables, copper wire, and fiber optics.

Computer-readable medium(s) 808 can further include instructions 812 for an operating system (e.g., Mac OS® server, Windows® NT server, Linux Server), instructions 814 for network communications module, data processing instructions 816, and interface instructions 818.

Operating systems can be multi-user, multiprocessing, multitasking, multithreading, real time, etc. Operating system performs basic tasks, including but not limited to: recognizing input from and providing output to devices 802, 804, 806 and 808; keeping track and managing files and directories on computer-readable medium(s) 808 (e.g., memory or a storage device); controlling peripheral devices; and managing traffic on the one or more communication channel(s) 810. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 816 include server-side or backend software for implementing the server-side operations. Interface instructions 818 includes software for implementing a web server and/or portal for sending and receiving data to and from user side computing devices and service side computing devices.

Architecture 800 can be implemented by a cloud computing system and can be included in any computer device, including one or more server computers in a local or distributed network each having one or more processing cores. Architecture 800 can be implemented in a parallel processing or peer-to-peer infrastructure or on a single device with one or more processors. Software can include multiple software components or can be a single body of code.

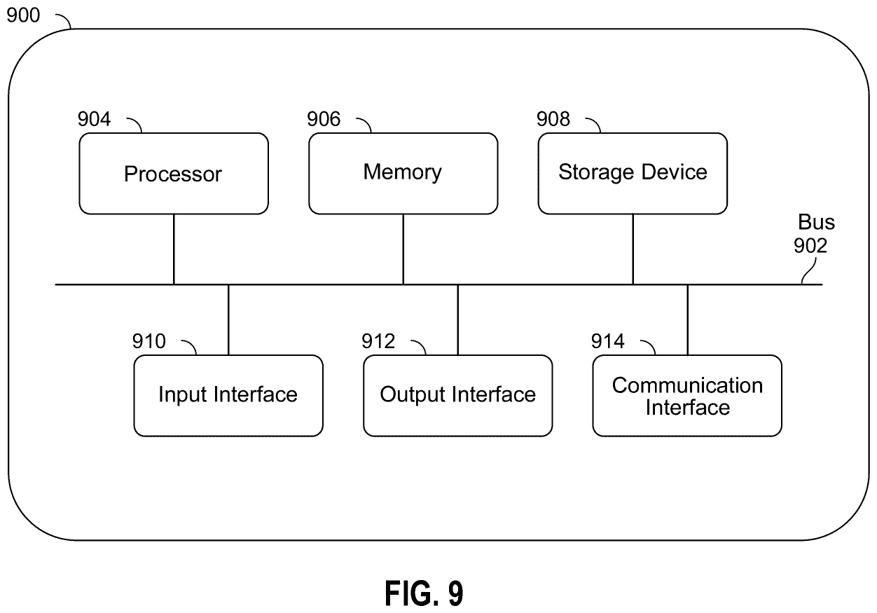

FIG. 9 is a block diagram illustrating an example architecture of a computing device 900 used to provide computational functionalities associated with described algorithms, methods, functions, processes, flows, and procedures. The computing device 900 can be implemented as the host system 100 of FIG. 1A. Other architectures are possible, including architectures with more or fewer components.

The computing device 900 includes processor 904, memory 906, storage component 908, input interface 910, output interface 912, communication interface 914, and bus 902. For example, the computing device 900 can use a PCIe switch between the processor 904 and the storage device 908 and/or the communication interface 914, where the process 904 can be a host device and the storage component 908 and the communication interface 914 can be PCIe device(s).

Bus 902 includes a component that permits communication among the components of the computing device 900. In some embodiments, processor 904 is implemented in hardware, software, or a combination of hardware and software. In some examples, processor 904 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 906 includes random access memory (RAM), read-only memory (ROM), and/or another type of dynamic and/or static storage device (e.g., flash memory, magnetic memory, optical memory, and/or the like) that stores data and/or instructions for use by processor 904.

Storage component 908 stores data and/or software related to the operation and use of the computing device 900. In some examples, storage component 908 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 910 includes a component that permits the computing device 900 to receive information, such as via user input (e.g., a touchscreen display, a keyboard, a keypad, a mouse, a button, a switch, a microphone, a camera, and/or the like). Additionally or alternatively, in some embodiments input interface 910 includes a sensor that senses information (e.g., a global positioning system (GPS) receiver, an accelerometer, a gyroscope, an actuator, and/or the like). Output interface 912 includes a component that provides output information from the computing device 900 (e.g., a display, a speaker, one or more light-emitting diodes (LEDs), and/or the like).

In some embodiments, communication interface 914 includes a transceiver-like component (e.g., a transceiver, a separate receiver and transmitter, and/or the like) that permits the computing device 900 to communicate with other devices via a wired connection, a wireless connection, or a combination of wired and wireless connections. In some examples, communication interface 914 permits the computing device 900 to receive information from another device and/or provide information to another device. In some examples, communication interface 914 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 900 performs one or more processes described herein. The computing device 900 performs these processes based on processor 904 executing software instructions stored by a computer-readable medium, such as memory 906 and/or storage component 908. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 906 and/or storage component 908 from another computer-readable medium or another device via communication interface 914. When executed, software instructions stored in memory 906 and/or storage component 908 cause processor 904 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 906 and/or storage component 908 includes data storage or at least one data structure (e.g., a database and/or the like). The computing device 900 is capable of receiving information from, storing information in, communicating information to, or searching information stored in the data storage or the at least one data structure in memory 906 or storage component 908. In some examples, the information includes network data, input data, output data, or any combination thereof.

In some embodiments, the computing device 900 is configured to execute software instructions that are either stored in memory 906 and/or in the memory of another device (e.g., another device that is the same as or similar to the computing device 900). As used herein, the term “module” refers to at least one instruction stored in memory 906 and/or in the memory of another device that, when executed by processor 904 and/or by a processor of another device (e.g., another device that is the same as or similar to the computing device 900) cause the computing device 900 (e.g., at least one component of the computing device 900) to perform one or more processes described herein. In some embodiments, a module is implemented in software, firmware, hardware, and/or the like.

The number and arrangement of components illustrated in FIG. 9 are provided as an example. In some embodiments, the computing device 900 can include additional components, fewer components, different components, or differently arranged components than those illustrated in FIG. 9. Additionally or alternatively, a set of components (e.g., one or more components) of the computing device 900 can perform one or more functions described as being performed by another component or another set of components of the computing device 900.

Described implementations of the subject matter can include one or more features, alone or in combination.

For example, in a first implementation, a device includes at least one peripheral component interconnect express (PCIe) switch correspondingly coupled to one or more PCIe devices; and a PCIe controller including an input port coupled to a device controller and at least one output port coupled to the at least one PCIe switch, where the device controller is configured to determine a target mode of the at least one PCIe switch based on a performance metric of each of the one or more PCIe devices, where the PCIe controller is configured to: receive a control signal indicative of the target mode of the at least one PCIe switch from the device controller, and based on the control signal, output a configuration signal indicative of the target mode to the at least one PCIe switch to set a mode of the at least one PCIe switch to be the target mode.

The foregoing and other described implementations can each, optionally, include one or more of the following features:

A first feature, combinable with any of the following features, the device includes the one or more PCIe devices, where the one or more PCIe devices, the at least one PCIe switch, and the PCIe controller are integrated in a same circuit board.

A second feature, combinable with any of the previous or following features, where the performance metric includes at least one of a device utilization, a power consumption, a temperature, a speed of fan, or a power supply current.

A third feature, combinable with any of the previous or following features, where the device controller is configured to: compare the performance metric of each of the one or more PCIe devices with at least one of a first threshold or a second threshold, the second threshold being greater than the first threshold; in response to the performance metric of each of the one or more PCIe devices being below the first threshold, determine the target mode of the at least one PCIe switch to be a first mode; in response to the performance metric of at least one of the one or more PCIe devices being above the first threshold and the performance metric of each of the one or more PCIe devices being below the second threshold, determine the target mode of the at least one PCIe switch to be a second mode; and in response to the performance metric of at least one of the one or more PCIe devices being above the second threshold, determine the target mode of the at least one PCIe switch to be a third mode.

A fourth feature, combinable with any of the previous or following features, where the first mode is a common mode, the second mode is a balance mode, and the third mode is a cascade mode, where the at least one PCIe switch includes a primary PCIe switch and one or more secondary PCIe switches, each of the at least one PCIe switch includes an upstream port and one or more downstream ports, and the one or more downstream ports are correspondingly coupled to the one or more PCIe devices, where, in the common mode, the upstream port of each of the at least one PCIe switch is coupled to a same processing device of a plurality of processing devices, where, in the balance mode, the upstream port of each of the at least one PCIe switch is coupled to a respective processing device of the plurality of processing devices, and where, in the cascade mode, the upstream port of the primary PCIe switch is coupled to a processing device of the plurality of processing devices, and the upstream port of one or more secondary PCIe switches is coupled to the primary PCIe switch in a cascade configuration.

A fifth feature, combinable with any of the previous or following features, where the device controller is configured to: in response to the performance metric of each of the one or more PCIe devices being below the first threshold, determine that the one or more PCIe devices are likely performing an interference operation; in response to the performance metric of at least one of the one or more PCIe devices being above the first threshold and the performance metric of each of the one or more PCIe devices being below the second threshold, determine that the one or more PCIe devices are likely performing a training operation; and in response to the performance metric of at least one of the one or more PCIe devices being above the second threshold, determine the one or more PCIe devices are likely performing both interference and training operations.

A sixth feature, combinable with any of the previous or following features, where the configuration signal includes a three-bit binary value, and the at least one output port of the PCIe controller includes three general purpose input/output (GPIO) pins.

A seventh feature, combinable with any of the previous or following features, where the one or more PCIe devices include at least one of one or more Graphics Processing Units (GPUs), one or more storage devices, one or more network devices, one or more sound devices, one or more capture devices, or one or more expansion cards.

An eighth feature, combinable with any of the previous or following features, where the device controller is configured to transmit the control signal indicative of the target mode of the at least one PCIe switch to the PCIe controller according to a communication protocol based on one of inter-integrated circuit (I2C), serial peripheral interface (SPI), system management bus (SMBus), or universal asynchronous receiver-transmitter (UART).

In a second implementation, a system includes a host device including at least one processing device and a device controller coupled to the at least one processing device; one or more PCIe devices; at least one peripheral component interconnect express (PCIe) switch correspondingly coupled to the one or more PCIe devices; and a PCIe controller including an input port coupled to the device controller and at least one output port coupled to the at least one PCIe switch, where the device controller is configured to determine a target mode of the at least one PCIe switch based on a performance metric of each of the one or more PCIe devices, and where the PCIe controller is configured to: receive a control signal indicative of the target mode of the at least one PCIe switch from the device controller, and based on the control signal, output a configuration signal indicative of the target mode to the at least one PCIe switch to set a mode of the at least one PCIe switch to be the target mode.

The foregoing and other described implementations can each, optionally, include one or more of the following features:

A first feature, combinable with any of the following features, where the one or more PCIe devices, the at least one PCIe switch, and the PCIe controller are integrated in a same circuit board.

A second feature, combinable with any of the previous or following features, where the performance metric includes at least one of a utilization, a power consumption, a temperature, a speed of fan, or a power supply current.

A third feature, combinable with any of the previous or following features, where the device controller is configured to: compare the performance metric of each of the one or more PCIe devices with at least one of a first threshold or a second threshold, the second threshold being greater than the first threshold; in response to the performance metric of each of the one or more PCIe devices being below the first threshold, determine the target mode of the at least one PCIe switch to be a first mode; in response to the performance metric of at least one of the one or more PCIe devices being above the first threshold and the performance metric of each of the one or more PCIe devices being below the second threshold, determine the target mode of the at least one PCIe switch to be a second mode; and in response to the performance metric of at least one of the one or more PCIe devices being above the second threshold, determine the target mode of the at least one PCIe switch to be a third mode.

A fourth feature, combinable with any of the previous or following features, where the first mode is a common mode, the second mode is a balance mode, and the third mode is a cascade mode, where the at least one PCIe switch includes a primary PCIe switch and one or more secondary PCIe switches, each of the at least one PCIe switch includes an upstream port and one or more downstream ports, and the one or more downstream ports are correspondingly coupled to the one or more PCIe devices, where, in the common mode, the upstream port of each of the at least one PCIe switch is coupled to a same processing device of a plurality of processing devices, where, in the balance mode, the upstream port of each of the at least one PCIe switch is coupled to a respective processing device of the plurality of processing devices, and where, in the cascade mode, the upstream port of the primary PCIe switch is coupled to a processing device of the plurality of processing devices, and the upstream port of one or more secondary PCIe switches is coupled to the primary PCIe switch in a cascade configuration.

A fifth feature, combinable with any of the previous or following features, where the at least one PCIe switch is configured to determine the performance metric of each of the one or more PCIe devices and transmit the performance metric of each of the one or more PCIe devices to the at least one processing device, and where the device controller is configured to receive the performance metric of each of the one or more PCIe devices from the at least one processing device.

A sixth feature, combinable with any of the previous or following features, where the at least one PCIe switch is configured to transmit the performance metric of each of the one or more PCIe devices to the at least one processing device based on at least one of a PCIe communication protocol or a compute express link (CXL) protocol.

A seventh feature, combinable with any of the previous or following features, where the device controller is configured to receive the performance metric of each of the one or more PCIe devices from the at least one processing device according to a communication protocol based on one of inter-integrated circuit (I2C), serial peripheral interface (SPI), system management bus (SMBus), or universal asynchronous receiver-transmitter (UART).

An eighth feature, combinable with any of the previous or following features, where the system includes a remote computing system configured to receive, from the host device, the performance metric of each of one or more PCIe devices and determine, based on the performance metric of each of one or more PCIe devices, the target mode.

In a third implementation, a method includes receiving, by a host device including at least one processing device and a device controller, a performance metric of each of one or more PCIe devices from at least one peripheral component interconnect express (PCIe) switch, the at least one PCIe switch including one or more downstream ports correspondingly coupled to the one or more PCIe devices and an upstream port coupled to the at least one processing device; determining a target mode of the at least one PCIe switch based on the performance metric of each of one or more PCIe devices; transmitting, by the device controller, a control signal indicative of the target mode of the at least one PCIe switch to a PCIe controller; and in response to the control signal, transmitting, by the PCIe controller, a configuration signal indicative of the target mode to the at least one PCIe switch to set a mode of the at least one PCIe switch to be the target mode.

The foregoing and other described implementations can each, optionally, include one or more of the following features:

A first feature, combinable with any of the following features, where determining the target mode of the at least one PCIe switch includes: comparing the performance metric of each of the one or more PCIe devices with at least one of a first threshold or a second threshold, the second threshold being greater than the first threshold; and determining the target mode of the at least one PCIe switch based on a result of the comparing, the determining including one of: in response to the performance metric of each of the one or more PCIe devices being below the first threshold, determining the target mode of the at least one PCIe switch to be a first mode; in response to the performance metric of at least one of the one or more PCIe devices being above the first threshold and the performance metric of each of the one or more PCIe devices being below the second threshold, determining the target mode of the at least one PCIe switch to be a second mode; or in response to the performance metric of at least one of the one or more PCIe devices being above the second threshold, determining the target mode of the at least one PCIe switch to be a third mode.

A second feature, combinable with any of the previous or following features, where determining the target mode of the at least one PCIe switch includes: determining the target mode of the at least one PCIe switch by the device controller.

A third feature, combinable with any of the previous or following features, where determining the target mode of the at least one PCIe switch includes: determining the target mode of the at least one PCIe switch by a trained model on a remote computing device, and where the method includes: transmitting, by the host device, the performance metric of each of one or more PCIe devices to the remote computing device to determine the target mode to the remote computing device; and receiving, by the host device, a signal indicative of the target mode of the at least one PCIe switch from the remote computing device.

A fourth feature, combinable with any of the previous or following features, the method includes updating, by a trained model on a remote computing device, at least one of the first threshold or the second threshold based on the performance metric of each of one or more PCIe devices.

A fifth feature, combinable with any of the previous or following features, the method includes determining another target mode of the at least one PCIe switch based on at least one of the updated first threshold or the updated second threshold.

A sixth feature, combinable with any of the previous or following features, where the performance metric includes at least one of a device utilization, a power consumption, a temperature, a speed of fan, or a power supply current.

A seventh feature, combinable with any of the previous or following features, the method includes in response to an event, sending, by the at least one processing device of the host device, a request for checking a current performance metric of each of the one or more PCIe devices to the at least one PCIe switch; and in response to the request, determining, by the at least one PCIe switch, the performance metric of each of the one or more PCIe devices.

An eighth feature, combinable with any of the previous or following features, the method includes periodically sending, by the at least one processing device of the host device, a request for checking a current performance metric of each of the one or more PCIe devices to the at least one PCIe switch; and in response to the request, determining, by the at least one PCIe switch, the performance metric of each of the one or more PCIe devices.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

The term “and/or” can refer to and encompasses any and all possible combinations of one or more of the associated listed terms. For example, the term “A and/or B” means that either option A, option B, or both options A and B are possible, where A and B may be singular or plural.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A device, comprising:
at least one peripheral component interconnect express (PCIe) switch correspondingly coupled to one or more PCIe devices; and
a PCIe controller comprising an input port coupled to a device controller and at least one output port coupled to the at least one PCIe switch, wherein the device controller is configured to determine a target mode of the at least one PCIe switch based on a performance metric of each of the one or more PCIe devices,
wherein the PCIe controller is configured to:
receive a control signal indicative of the target mode of the at least one PCIe switch from the device controller; and
based on the control signal, output a configuration signal indicative of the target mode to the at least one PCIe switch to set a mode of the at least one PCIe switch to be the target mode.

2. The device of claim 1, wherein the performance metric comprises at least one of a device utilization, a power consumption, a temperature, a speed of fan, or a power supply current.

3. The device of claim 1, wherein the device controller is configured to:
compare the performance metric of each of the one or more PCIe devices with at least one of a first threshold or a second threshold, the second threshold being greater than the first threshold;
in response to the performance metric of each of the one or more PCIe devices being below the first threshold, determine the target mode of the at least one PCIe switch to be a first mode;
in response to the performance metric of at least one of the one or more PCIe devices being above the first threshold and the performance metric of each of the one or more PCIe devices being below the second threshold, determine the target mode of the at least one PCIe switch to be a second mode; and
in response to the performance metric of at least one of the one or more PCIe devices being above the second threshold, determine the target mode of the at least one PCIe switch to be a third mode.

4. The device of claim 3, wherein the first mode is a common mode, the second mode is a balance mode, and the third mode is a cascade mode,
wherein the at least one PCIe switch comprises a primary PCIe switch and one or more secondary PCIe switches, each of the at least one PCIe switch comprises an upstream port and one or more downstream ports, and the one or more downstream ports are correspondingly coupled to the one or more PCIe devices,
wherein, in the common mode, the upstream port of each of the at least one PCIe switch is coupled to a same processing device of a plurality of processing devices,
wherein, in the balance mode, the upstream port of each of the at least one PCIe switch is coupled to a respective processing device of the plurality of processing devices, and
wherein, in the cascade mode, the upstream port of the primary PCIe switch is coupled to a processing device of the plurality of processing devices, and the upstream port of one or more secondary PCIe switches is coupled to the primary PCIe switch in a cascade configuration.

5. The device of claim 3, wherein the device controller is configured to:
in response to the performance metric of each of the one or more PCIe devices being below the first threshold, determine that the one or more PCIe devices are likely performing an interference operation;
in response to the performance metric of at least one of the one or more PCIe devices being above the first threshold and the performance metric of each of the one or more PCIe devices being below the second threshold, determine that the one or more PCIe devices are likely performing a training operation; and
in response to the performance metric of at least one of the one or more PCIe devices being above the second threshold, determine the one or more PCIe devices are likely performing both interference and training operations.

6. The device of claim 1, wherein the configuration signal comprises a three-bit binary value, and the at least one output port of the PCIe controller comprises three general purpose input/output (GPIO) pins.

7. The device of claim 1, wherein the one or more PCIe devices comprise at least one of one or more Graphics Processing Units (GPUs), one or more storage devices, one or more network devices, one or more sound devices, one or more capture devices, or one or more expansion cards.

8. A system, comprising:
a host device comprising at least one processing device and a device controller coupled to the at least one processing device;
one or more PCIe devices;
at least one peripheral component interconnect express (PCIe) switch correspondingly coupled to the one or more PCIe devices; and
a PCIe controller comprising an input port coupled to the device controller and at least one output port coupled to the at least one PCIe switch,
wherein the device controller is configured to determine a target mode of the at least one PCIe switch based on a performance metric of each of the one or more PCIe devices, and
wherein the PCIe controller is configured to:
receive a control signal indicative of the target mode of the at least one PCIe switch from the device controller, and
based on the control signal, output a configuration signal indicative of the target mode to the at least one PCIe switch to set a mode of the at least one PCIe switch to be the target mode.

9. The system of claim 8, wherein the performance metric comprises at least one of a utilization, a power consumption, a temperature, a speed of fan, or a power supply current.

10. The system of claim 8, wherein the device controller is configured to:
compare the performance metric of each of the one or more PCIe devices with at least one of a first threshold or a second threshold, the second threshold being greater than the first threshold;
in response to the performance metric of each of the one or more PCIe devices being below the first threshold, determine the target mode of the at least one PCIe switch to be a first mode;
in response to the performance metric of at least one of the one or more PCIe devices being above the first threshold and the performance metric of each of the one or more PCIe devices being below the second threshold, determine the target mode of the at least one PCIe switch to be a second mode; and
in response to the performance metric of at least one of the one or more PCIe devices being above the second threshold, determine the target mode of the at least one PCIe switch to be a third mode.

11. The system of claim 10, wherein the first mode is a common mode, the second mode is a balance mode, and the third mode is a cascade mode,
wherein the at least one PCIe switch comprises a primary PCIe switch and one or more secondary PCIe switches, each of the at least one PCIe switch comprises an upstream port and one or more downstream ports, and the one or more downstream ports are correspondingly coupled to the one or more PCIe devices,
wherein, in the common mode, the upstream port of each of the at least one PCIe switch is coupled to a same processing device of a plurality of processing devices,
wherein, in the balance mode, the upstream port of each of the at least one PCIe switch is coupled to a respective processing device of the plurality of processing devices, and
wherein, in the cascade mode, the upstream port of the primary PCIe switch is coupled to a processing device of the plurality of processing devices, and the upstream port of one or more secondary PCIe switches is coupled to the primary PCIe switch in a cascade configuration.

12. The system of claim 8, wherein the at least one PCIe switch is configured to determine the performance metric of each of the one or more PCIe devices and transmit the performance metric of each of the one or more PCIe devices to the at least one processing device, and
wherein the device controller is configured to receive the performance metric of each of the one or more PCIe devices from the at least one processing device.

13. The system of claim 8, comprising:
a remote computing system configured to receive, from the host device, the performance metric of each of one or more PCIe devices and determine, based on the performance metric of each of one or more PCIe devices, the target mode.

14. A method, comprising:
receiving, by a host device comprising at least one processing device and a device controller, a performance metric of each of one or more PCIe devices from at least one peripheral component interconnect express (PCIe) switch, the at least one PCIe switch comprising one or more downstream ports correspondingly coupled to the one or more PCIe devices and an upstream port coupled to the at least one processing device;
determining a target mode of the at least one PCIe switch based on the performance metric of each of one or more PCIe devices;
transmitting, by the device controller, a control signal indicative of the target mode of the at least one PCIe switch to a PCIe controller; and
in response to the control signal, transmitting, by the PCIe controller, a configuration signal indicative of the target mode to the at least one PCIe switch to set a mode of the at least one PCIe switch to be the target mode.

15. The method of claim 14, wherein determining the target mode of the at least one PCIe switch comprises:
comparing the performance metric of each of the one or more PCIe devices with at least one of a first threshold or a second threshold, the second threshold being greater than the first threshold; and
determining the target mode of the at least one PCIe switch based on a result of the comparing, the determining comprising one of:
in response to the performance metric of each of the one or more PCIe devices being below the first threshold, determining the target mode of the at least one PCIe switch to be a first mode;
in response to the performance metric of at least one of the one or more PCIe devices being above the first threshold and the performance metric of each of the one or more PCIe devices being below the second threshold, determining the target mode of the at least one PCIe switch to be a second mode; or
in response to the performance metric of at least one of the one or more PCIe devices being above the second threshold, determining the target mode of the at least one PCIe switch to be a third mode.

16. The method of claim 15, wherein determining the target mode of the at least one PCIe switch comprises: determining the target mode of the at least one PCIe switch by the device controller.

17. The method of claim 15, wherein determining the target mode of the at least one PCIe switch comprises: determining the target mode of the at least one PCIe switch by a trained model on a remote computing device, and
wherein the method comprises:
transmitting, by the host device, the performance metric of each of one or more PCIe devices to the remote computing device to determine the target mode to the remote computing device; and
receiving, by the host device, a signal indicative of the target mode of the at least one PCIe switch from the remote computing device.

18. The method of claim 15, comprising:
updating, by a trained model on a remote computing device, at least one of the first threshold or the second threshold based on the performance metric of each of one or more PCIe devices.

19. The method of claim 14, comprising:
in response to an event, sending, by the at least one processing device of the host device, a request for checking a current performance metric of each of the one or more PCIe devices to the at least one PCIe switch; and
in response to the request, determining, by the at least one PCIe switch, the performance metric of each of the one or more PCIe devices.

20. The method of claim 14, comprising:
periodically sending, by the at least one processing device of the host device, a request for checking a current performance metric of each of the one or more PCIe devices to the at least one PCIe switch; and
in response to the request, determining, by the at least one PCIe switch, the performance metric of each of the one or more PCIe devices.
